(19) United States
(12) Patent Application Publication
(10) Pub. No.: US 2013/0024646 A1
(43) Pub. Date: Jan. 24, 2013

(54) Method and Simulator for Simulating Multiprocessor Architecture Remote Memory Access

(71) Applicants: Yi Liu, Shenzhen (CN); Xi Tan, Shenzhen (CN); Gang LIU, Hangzhou (CN); Jin Wu, Shenzhen (CN)

(72) Inventors: Yi Liu, Shenzhen (CN); Xi Tan, Shenzhen (CN); Gang LIU, Hangzhou (CN); Jin Wu, Shenzhen (CN)

(73) Assignee: HUAWEI TECHNOLOGIES CO., LTD., Shenzhen (CN)

(21) Appl. No.: 13/554,827

(22) Filed: Jul. 20, 2012

Related U.S. Application Data
(63) Continuation of application No. PCT/CN2011/077377, filed on Jul. 20, 2011.

(51) Int. Cl. G06F 12/10

(52) U.S. Cl. 711/206; 711/203; 711/E12.059

(57) ABSTRACT

A method for simulating remote memory access in a target machine on a host machine is disclosed. Multiple virtual memory spaces in the host machine are divided and a virtual address space of each target application process is set to one virtual memory space that corresponds to a target application process and is in the multiple virtual memory spaces. Access of the target application process is captured to a virtual memory space other than the virtual memory space corresponding to the target application process in the multiple virtual memory spaces.

### CROSS-REFERENCE TO RELATED APPLICATIONS

This application is a continuation of International Application No. PCT/CN2011/077377, filed on Jul. 20, 2011, which is hereby incorporated by reference in its entirety.

### FIELD OF THE INVENTION

The present invention relates to the simulation technologies, and in particular, to a method, a device and a simulator for simulating multiprocessor architecture remote memory access on a host machine.

### BACKGROUND OF THE INVENTION

In the development of the computer system, simulation/emulation is an important research means and tool. In one aspect, by using a simulation method, a pre-performance evaluation and test may be performed on a system design solution, which facilitates understanding of the system performance and a bottleneck that may exist. In another aspect, when no hardware platform is available, a simulation system may be used as a software development and debugging platform. Since the simulation technology can significantly reduce the design cost and shorten the design cycle, system structure simulation has become an indispensable part in computer system design.

The NUMA (Non Uniform Memory Architecture, non uniform memory architecture) is relative to the SMP (Symmetric Multiprocessing, symmetric multiprocessing). In the SMP system, since all processors share a system bus, when the number of the processors increases, conflicts of competition for the system bus increases, and the system bus may become a bottleneck. In the NUMA architecture, processors and memories are organized through nodes, and the nodes are connected through a high-speed interconnection network, to finally form a hardware system. Therefore, the NUMA system has a better extensibility. As for a single processor, it may access a local memory (local memory) of a local node and may also access a remote memory (remote memory) of another node. Since the access to the remote memory needs to be performed through the interconnection network, in the NUMA system, a time delay of a processor in accessing the local memory and a time delay of the processor in accessing the remote memory vary widely, and the remote memory access has a great influence on the system performance. Therefore, when the NUMA system is simulated, the simulation of the remote memory access behavior is one of the key factors that determine the performance and the accuracy of a NUMA system simulator.

Currently, most of the mainstream system structure simulators (such as SimpleScalar and SimOS) adopt a hierarchical modular structure, that is, on the basis of modeling hardware of a target machine, completing modeling an instruction set system and an I/O interface of the target machine. Simulation of the target machine is completed by using an execution-driven technology.

Taking SimpleScalar as an example, the simulator adopts a hierarchical modular structure. First, hardware models of the target machine are abstracted. For example, models of an instructor, a pipeline, a branch predictor, a memory, a cache and a memory management unit (MMU) are abstracted. On this basis, the simulator models an instruction system used by the target machine. When a target program is run on the simulator, the simulator analyzes an instruction and invokes a corresponding module (for example, as for a memory-reference instruction, invoking a memory management module and a memory module), so as to complete simulation of the target machine. The SimpleScalar differentiates a memory-reference instruction and a non-memory-reference instruction, uses an LSQ (load/store queue) to record storage-related information, checks an LSD queue to find out storage blocking information, and calculates a memory access delay.

When this simulation technology is used to simulate the NUMA system, the hardware and the instruction system need to be modeled, and instructions need to be analyzed one by one in the simulation procedure. Although the simulation accuracy is high, the modeling procedure is complex, and the workload is heavy; and moreover, the instruction analysis is time-consuming, and the efficiency is low.

As for the NUMA system that is more and more widely used currently, it is beneficial to use a high-efficiency simulation technology.

### SUMMARY OF THE INVENTION

Embodiments of the present invention provide a high-efficiency simulation method for simulating remote memory access in a system such as a NUMA system. In this method, a virtual storage system of a host machine is used to simulate physical memories of the NUMA system (that is, a target machine), so that capture and simulation of a remote memory access event in the NUMA system may be implemented through a page fault interrupt of the virtual storage system of the host machine.

In one aspect, an embodiment of the present invention provides a method for simulating remote memory access in a target machine on a host machine, including: dividing multiple virtual memory spaces in the host machine; setting a virtual address space of each target application process to one virtual memory space that corresponds to the target application process and is in the multiple virtual memory spaces; and capturing access of the target application process to a virtual memory space other than the virtual memory space corresponding to the target application process in the multiple virtual memory spaces.

In another aspect, an embodiment of the present invention further provides a device for simulating remote memory access in a target machine on a host machine, including: a unit for dividing multiple virtual memory spaces in the host machine; a unit for setting a virtual address space of each target application process to one virtual memory space that corresponds to the target application process and is in the multiple virtual memory spaces; and a unit for capturing access of the target application process to a virtual memory space other than the virtual memory space corresponding to the target application process in the multiple virtual memory spaces.

In another aspect, an embodiment of the present invention further provides a simulator for simulating remote memory access in a target machine, including: a memory mapping module, configured to divide multiple virtual memory spaces in a host machine; an application process setting module, configured to set a virtual address space of each target application process to one virtual memory space that corresponds to the target application process and is in the multiple virtual memory spaces; and a capture module, configured to capture access of the target application process to a virtual memory space other than the virtual memory space corresponding to the target application process in the multiple virtual memory spaces.

In another aspect, an embodiment of the present invention further provides a host machine including the foregoing simulator.

In another aspect, an embodiment of the present invention further provides a host machine, including: a storage and a processor. The processor is configured to: divide multiple virtual memory spaces in the storage; set a virtual address space of each target application process to one virtual memory space that corresponds to the target application process and is in the multiple virtual memory spaces; and capture access of the target application process to a virtual memory space other than the virtual memory space corresponding to the target application process in the multiple virtual memory spaces.

In another aspect, an embodiment of the present invention further provides a system for simulating remote memory access, including: a storage for storing an instruction and a processor for executing the instruction, so that the system is enabled to execute the foregoing method of the present invention.

In another aspect, an embodiment of the present invention further provides a machine-readable medium, in which an instruction is stored. When a machine executes the instruction, the machine is enabled to execute the foregoing method of the present invention.

In another aspect, an embodiment of the present invention further provides a computer program, where the computer program is used to execute the foregoing method of the present invention.

Different from the simulation technology in the prior art, the simulation technology of the present invention simplifies the complex modeling procedure and instruction analysis procedure in the prior art, and has a characteristic of being simple and high efficient. By setting a process address space, access to the virtual memory space corresponding to a local node memory that is on the target machine that is simulated is not influenced during an execution procedure of the target application process on a host machine, and when a virtual memory space range corresponding to a remote node memory that is on the target machine is accessed, the virtual storage system of the operating system triggers a page fault interrupt, and the page fault interrupt is captured and simulated by the simulator. This procedure has no influence on the normal operation of the operating system and programs, and moreover, as compared with an existing simulation method, the program simulation execution has a higher efficiency. Therefore, simulation performance of a system such as the NUMA system may be improved.

Other objectives and effects of the present invention will be clearer and more comprehensible with reference to the illustration of the accompanying drawings and the content of the appended claims and with more comprehensive understanding of the embodiments of the present invention.

### BRIEF DESCRIPTION OF THE DRAWINGS

The present invention is described in detail below through embodiments with reference to the accompanying drawings.

FIG. 1 is a schematic diagram for illustrating a logic relationship between a virtual memory space in a hose machine and a physical memory of each node in a target machine according to an embodiment of the present invention;

FIG. 2 is a flow chart of a method for simulating remote memory access of a target machine on a host machine according to an embodiment of the present invention;

FIG. 3 is a flow chart of a method for capturing remote memory access according to an embodiment of the present invention;

FIG. 4 is a schematic diagram of a host machine including a NUMA system simulator according to an embodiment of the present invention;

FIG. 5 shows a device for simulating remote memory access according to an embodiment of the present invention; and

FIG. 6 is a host machine implemented according to an embodiment of the present invention.

In all the accompany drawings, a same label is used to indicate a similar or corresponding feature or function.

### DETAILED DESCRIPTION OF THE EMBODIMENTS

In the following, a NUMA system is taken as an example to describe a simulation method of the present invention. It should be noted that, the present invention is not limited to simulation of the NUMA system, as for any system involving a remote memory access operation, regardless of the name of system, the method of the present invention may be used to simulate remote memory access of the system.

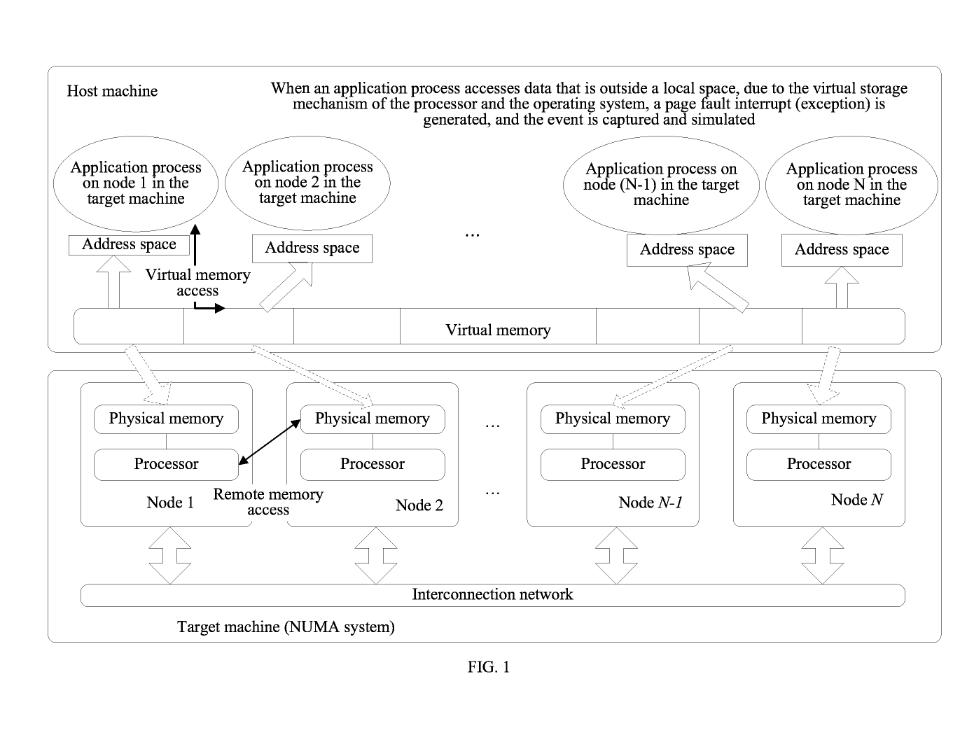

FIG. 1 is a schematic diagram for illustrating a logic relationship between a virtual memory space in a hose machine and a physical memory of each node in a target machine according to an embodiment of the present invention.

As shown in the figure, the target machine that is simulated has a NUMA system structure, and the system includes 1 to N multiple nodes. Each node includes a processor and a local memory, and the nodes are connected through a high-speed interconnection network. The whole NUMA system has a uniform memory address space, but its memories are physically distributed on the nodes, and a delay of the node in accessing the local memory and a delay of the node in accessing a remote memory of another node are different, and it is also a reason for why the system is referred to as a non uniform memory architecture. In the NUMA system, a time delay of a processor in accessing the local memory and a time delay of the processor in accessing the remote memory vary widely, which has a great influence on the system performance. Therefore, when the NUMA system is simulated, the simulation of remote memory access behavior is one of the key factors that determine the performance and the accuracy of the NUMA system simulator.

According to the embodiment shown in FIG. 1, in order to simulate the target machine NUMA system, a mapping relationship may be established between the host machine and the target machine. Firstly, a mapping relationship between a process virtual memory space in the hose machine and a physical memory of each node in the NUMA system is established, so that the process virtual memory space of the host machine logically corresponds to the physical memories of the nodes in the target machine, so that the process virtual memory spaces in the host machine is used to simulate the physical memory of each node in the NUMA system. Secondly, a mapping relationship between a target application process corresponding to the process virtual memory space in the host machine and an application process on a corresponding node in the NUMA system is established.

When the first mapping relationship is established, as shown in FIG. 1, as for a target machine that has N nodes, N virtual memory spaces are divided in the host machine, and the N virtual memory spaces are corresponded to physical memories of N nodes in the target machine. For example, a size of each virtual memory space in the host machine is equal to a size of the physical memory of the corresponding node in the target machine.

When a correspondence relationship between the process virtual memory space of the host machine and the physical memory of each node in the NUMA system is established, an appropriate mapping policy always enables the simulator to be closer to the real target machine. For example, an address-based mapping policy may be adopted as follows. A total virtual memory space of the host machine is first set, so as to enable a size of the total virtual memory space to be equal to a sum of the physical memories of the nodes in the target machine; and then, a virtual memory address of the total virtual memory space of the host machine and a physical memory address of the target machine are one-to-one mapped. As shown in FIG. 1, in an example, the target machine has N nodes in total, and the sizes of physical memories of each node are the same, so the total virtual memory space of the host machine is divided into N blocks that have the same size, and the virtual memory space blocks are corresponded to the physical memories of the nodes of the target machine one by one in an address growing manner.

It may be understood that, division of the virtual memory space in the host machine is not limited to a specific manner, and sizes of the divided multiple virtual memory spaces may be the same or different. The divided multiple virtual memory space blocks may be continuous or discontinuous, and the correspondence relationships between the multiple virtual memory space blocks in the host machines and the physical memories of the multiple nodes in the target machine may be established in various sequences, as long as the relationships between the multiple virtual memory spaces in the host machine and the physical memories of the multiple nodes in the target machine are one-to-one mapping relationships.

In the second mapping relationship, the target application process corresponding to the virtual memory space in the host machine is mapped to the target machine node process that is executed on the corresponding node in the target machine, where the virtual address space of the target application process in the host machine is set to the physical memory space corresponding to a node where the process is run in the NUMA system. For example, by setting a process address space that the target application process is enabled to access in the host machine to a range of the virtual memory space corresponding to the target application process, when a target application process that is run in a certain virtual memory space accesses an address of another virtual memory space, a page fault interrupt (for example, exception, exception) caused by the process is generated. The access may be captured by capturing the page fault interrupt, and the captured access is considered as simulation of remote access of a process on a corresponding node in the target machine to the physical memory of another node occurs.

According to an embodiment, a physical memory size parameter in the configuration information of the target application process in the host machine may be set to a size of the virtual memory space that corresponds to the application process, which corresponds to the physical memory size of the node where the application process is run in the target machine. In this way, the behavior that the application process accesses the remote memory in the target machine is simulated as a behavior that the target application process accesses another virtual memory space other than the virtual memory space corresponding to the target application process in the host machine. Under the action of the virtual storage system of the operating system, when the target application process accesses a memory space other than the memory space that is allocated to the target application process and has a specific size, the memory access behavior generates a page fault interrupt (exception, exception) in the host machine system, so that capture and simulation of the remote memory access event in the NUMA system may be implemented by using the page fault interrupt.

The reasonableness of the mapping policy affects the accuracy of the simulator to some extent. Generally, according to the corresponding mechanism between the target machine processes that are run on the target machine and the multiple nodes, the application process on the host machine may be set to a corresponding virtual memory space in the multiple virtual memory spaces in the host machine for local running. For example, the mapping may be completed according to the “load balancing strategy”, that is, a requirement that the workloads of the processes on different nodes of the target machine are substantially the same is met to the greatest extent. In an example, a load balancing strategy may be implemented in a sequence cycle manner, for example, according to the process number, target application processes 1 to N on the host machine are respectively set to be corresponding to 1^{st} to N^{th} virtual memory space blocks, and target application processes N+1 to 2N on the host machine are further respectively set to be corresponding to the 1^{st} to N^{th} virtual memory space blocks, and so on. Through the foregoing process mapping, as shown in FIG. 1: a target application process corresponding to a first virtual memory space of the host machine may be used to simulate a process on node 1 of the target machine; a target application process corresponding to a second virtual memory space of the host machine may be used to simulate a process on node 2 of the target machine, and so on; a target application process corresponding to an N^{th} virtual memory space on the host machine may be used to simulate a process on node N of the target machine. According to an embodiment, a process address space that each target application process is enabled to access is set to a virtual memory space corresponding to the target application process. According to another embodiment, the process address space that the target application process is enabled to access is not directly set, but a size of a physical memory in the configuration information of the target application process in the host machine is set, that is, the size of the physical memory in the configuration information of the target application process in the host machine is set to be equal to the size of the physical memory of the corresponding node in the target machine.

Through the foregoing mapping relationship, a divided virtual memory space in the host machine may be used to simulate a node in the target machine or a physical memory of the node, and the target application process corresponding to the virtual memory space in the host machine may be used to simulate the process on the corresponding node in the target machine, and further, the captured access of the application process corresponding to the virtual memory space in the host machine to another virtual memory space may be used to simulate the access of the process on the corresponding node in the target machine. When the access of the target application process to another virtual memory space other than the virtual memory space corresponding to the target application process is captured, it is equivalent to that the remote memory access on the target machine that is simulated is captured, and according to the model of the interconnection network of the target machine, a time delay of the remote memory access and other simulation data are calculated. Optionally, but not necessarily, the access to another virtual memory space may be executed after the time delay is passed. For example, after the time delay is passed, a memory page where the access address exists is loaded to the memory space of the application process.

According to an embodiment, when a page fault interrupt is generated and a form feed operation is initiated in a host machine virtual memory system due to the target application process that is run in the host machine, the virtual memory space that the target application process intends to access may be determined by capturing and analyzing the page fault interrupt and the form feed operation, and it is considered as an operation that a corresponding process in the NUMA system accesses a corresponding remote memory occurs. According to the foregoing mapping relationship, a node on which the process in the NUMA system accesses the remote memory access and the accessed memory address may be determined. Further, according to the model of the interconnection network between the nodes in the NUMA system, the time delay of the remote memory access behavior and other simulation data may be calculated.

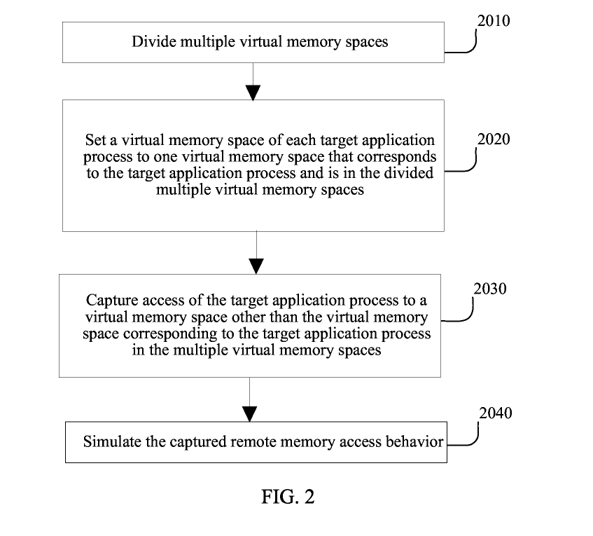

FIG. 2 is a flow chart of a method for simulating remote memory access of a target machine on a host machine according to an embodiment of the present invention.

In step 2010, divide multiple virtual memory spaces in a host machine. The divided multiple virtual memory spaces serve as virtual memory spaces corresponding to physical memories of nodes in the target machine. According to an embodiment, when the multiple virtual memory spaces are divided, the address-based mapping policy described with reference to FIG. 1 may be adopted.

In step 2020, each target application process that is run in the host machine is set to be corresponding to one virtual memory space in the divided multiple virtual memory spaces. According to an embodiment, the process address space that each target application process is enabled to access is set to a range of one virtual memory space that corresponds to the application process and is in the divided multiple virtual memory spaces. According to another embodiment, the setting the process address space that the target application process is enabled to access can be replaced with a simpler manner, that is, a physical memory size in configuration information of the target application process is set to be equal to a size of the virtual memory space that corresponds to the target application process. Through this setting, when the target application process accesses a memory space other than the memory space that is allocated to the target application process and has a set size, the access behavior generates one page fault interrupt in a host machine system, and the page fault interrupt may be used to simulate remote memory access in the target machine. For example, when the page fault interrupt is captured, a process number of the target application process that causes the page fault interrupt and an address that is to be accessed may be obtained, and according to the correspondence relationship mentioned above, the virtual memory space corresponding to the process and the virtual memory space corresponding to the address that is to be accessed may be obtained, so that it can be considered that remote access of the corresponding target machine node process to the physical memory of another node occurs in the target machine, thereby completing a simulation operation. According to an embodiment, when the foregoing target application process is run, to respond to a memory allocation request of the application process, a memory is allocated to the application process from the divided multiple virtual memory spaces. If a part of the memory that is allocated to the application process is outside the process address space that the application process is enabled to access, a page fault interrupt is generated when the application process access allocates this part of memory to the application process.

In step 2030, capture access of the target application process to a virtual memory space other than the virtual memory space corresponding to the target application process. According to an embodiment, non-local memory access of the application process may be captured by capturing the page fault interrupt generated by the target application process. When the access of the application process to the virtual memory space other than the virtual memory space corresponding to the target application process, according to the two foregoing mapping relationships, it is equivalent to that remote access of the corresponding target machine node process to the physical memory of another node occurs in the target machine that is simulated.

In step 2040, simulate the captured remote memory access behavior. For example, a delay of the captured remote memory access is calculated according to a model of an interconnection network between the multiple nodes of the target machine. More specifically, an interconnection network in the target machine may be modeled, and the model of the interconnection network is used to calculate a time delay of the remote memory access in the target machine and other simulation information. According to an embodiment, after the time delay is passed, a page where the access address exists is loaded to the memory space of the application process. Here, a method for modeling a interconnection network of the NUMA system is known in the prior art, so no further description of the model of the interconnection network of the NUMA system is provided here again.

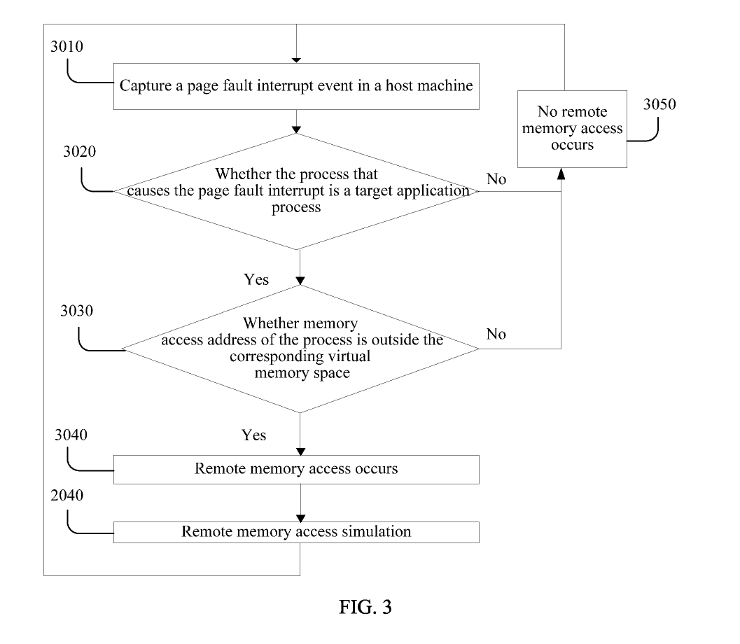

FIG. 3 is a flow chart of a method for capturing remote memory access according to an embodiment of the present invention, where the method corresponds to step 2030 in FIG. 2.

In the following, a Linux operating system is taken as an example to describe the embodiment of the present invention. It can be understood that, the present invention may also be implemented in other operating systems.

In step 3010, capture a page fault interrupt event in a host machine. For example, a capture module that is run under the Linux kernel may be created in a NUMA system simulator, and the capture module adds a probe to a form feed function of the system, so that the probe is triggered when the host machine system invokes the form feed function, thereby capturing a page fault interrupt even.

In step 3020, the capture module or a probe function judges whether the process that causes the page fault interrupt is a target application process, that is, one of the application processes that is set to be corresponding to the divided virtual memory spaces. For example, after the page fault interrupt event is captured, the capture module may obtain, according to the interrupt information, a process number of the process that causes the page fault interrupt; and according to an address of the page fault interrupt, calculate a virtual memory address that the process intends to access. For example, judgment in step 3020 may be performed by using the process number. If the judgment result is yes, continuously perform step 3030; and if the judgment result is not, as shown in block 3050, it is indicated that no access to the virtual memory space corresponding to the remote memory access in the target machine occurs in the host machine, return to step 3010.

In step 3030, judge whether the virtual memory address that the target application process that causes the form feed interrupt intends to access is outside the virtual memory space corresponding to the application process. If the judgment result is yes, as shown in block 3040, it is indicated that access to the virtual memory space corresponding to the remote memory access in the target machine occurs in the host machine, perform step 2040; and if the judgment result is not, as shown in block 3050, it is indicated that no access to the virtual memory space corresponding to the remote memory access in the target machine occurs in the host machine, return to step 3010.

In step 2040, as mentioned above, the capture module may obtain, according to the interrupt information, the process number of the application process that causes the interrupt and the address that application process intends to access. According to the mapping relationships between the virtual memory spaces of the host machine and the nodes of the target machine, a memory access node and a memory accessed node that correspond to the application process that causes the interrupt on the target machine may be obtained, and according to the interconnection network structure of the NUMA system, a time delay of the remote memory access is calculated.

It should be noted that, blocks 3040 and 3050 in FIG. 3 are shown for convenience of clearly illustration of the judgment result, and in an actual process, the steps in these two blocks will not be performed.

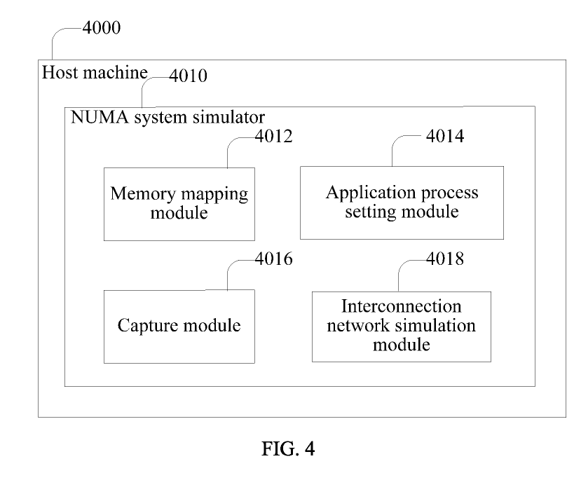

FIG. 4 is a block diagram of a host machine including a NUMA system simulator according to an embodiment of the present invention. As shown in FIG. 4, the host machine 4000 includes a NUMA system simulator 4010, and the simulator includes a memory mapping module 4012, an application process setting module 4014, a capture module 4016 and an interconnection network simulation module 4018. The memory mapping module is configured to divide multiple virtual memory spaces in a host machine. The application process setting module is configured to set a virtual address space of each target application process to one virtual memory space that corresponds to the target application process and is in the divided multiple virtual memory spaces, in other words, each target application process is mapped to a virtual address space, where the virtual address space is one virtual memory space that corresponds to the application process and is in the divided multiple virtual memory spaces. The capture module is configured to capture access of the target application process to a virtual memory space other than the virtual memory space corresponding to the target application process in the multiple virtual memory spaces. The interconnection network simulation module is configured to simulate, according to a model of an interconnection network between multiple nodes in the target machine, remote memory access on the target machine corresponding to the captured access, for example, calculate a time delay of the captured remote memory access and other information.

According to an embodiment, the memory mapping module sets the divided multiple virtual memory spaces to have the same size as the multiple physical memories of corresponding multiple nodes in the target machine respectively. According to an embodiment, the memory mapping module divides a total virtual memory space in the host machine, and divides the total virtual memory space into the foregoing multiple virtual memory spaces, where a size of the total virtual memory space is equal to a sum of sizes of physical memories of multiple nodes in the target machine. According to an embodiment, the memory mapping module maps an address of the total virtual memory space of the host machine to addresses of the physical memories of the multiple nodes of the target machine one by one, and divides the total virtual memory space of the host machine into the foregoing multiple virtual memory spaces of the same size, where the multiple virtual memory spaces correspond to the physical memories of the multiple nodes in the target machine respectively in an address growing manner.

According to an embodiment, the application process setting module sets a process address space that each target application process is enabled to access to a range of the virtual memory space corresponding to the target application process. According to an embodiment, the application process setting module sets a size of the physical memory in configuration information of each target application process to a size of the virtual memory space that corresponds to the target application process. According to an embodiment, the application process setting module sets the target application process in the hose machine on a corresponding virtual memory space of the multiple virtual memory spaces according to a corresponding mechanism between the target machine process and the multiple nodes on the target machine. According to an embodiment, the application process setting module sets the target application process on the corresponding virtual memory space of the multiple virtual memory spaces in the host machine according to a load balancing policy, so that workloads of the target application process corresponding to the virtual memory space of the multiple virtual memory spaces in the host machine are the same as possible. According to an embodiment, the application process setting module sets the target application processes on the multiple virtual memory spaces in the host machine one by one in a sequence cycle manner.

According to an embodiment, the capture module captures a page fault interrupt generated because the target application process accesses a virtual memory space other than the virtual memory space corresponding to the target application process. According to an embodiment, the capture module captures a page fault interrupt caused by the application process on the host machine, and judges whether a memory address that the application process that causes the page fault interrupt intends to access is outside the virtual memory space corresponding to the application process. According to an embodiment, the capture module adds a probe on a system form feed function of the host machine, captures the page fault interrupt on the host machine to respond to that the probe is triggered, and judges whether the application process that causes the page fault interrupt is the target application process; and if yes, optionally, judges whether the memory address that the application process that causes the page fault interrupt intends to access is outside the virtual memory space corresponding to the application process. According to an embodiment, the capture module determines that remote memory access occurs when the memory address that the application process that causes the page fault interrupt intends to access is outside the virtual memory space corresponding to the application process, and determines that no remote memory access occurs when the memory address that the application process that causes the page fault interrupt intends to access is in the virtual memory space corresponding to the application process.

According to an embodiment, the interconnection network simulation module simulates, according to a model of an interconnection network between multiple nodes in the target machine, remote memory access on the target machine corresponding to the captured access, for example, a time delay of the remote memory access on the target machine corresponding to the captured access in host machine is calculated. According to an embodiment, optionally, the interconnection network simulation module loads, after the calculated time delay is passed, a memory page where the access address of the application process that causes the page fault interrupt exists to the virtual memory space of the application process.

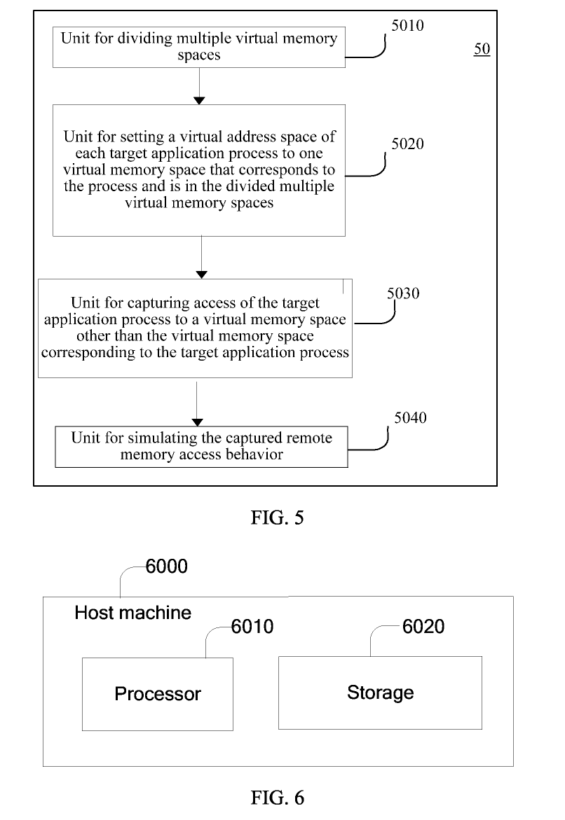

FIG. 5 shows a device for simulating remote memory access according to an embodiment of the present invention. As shown in FIG. 5, the device includes: a unit 5010 for dividing multiple virtual memory spaces in a host machine; a unit 5020 for setting a virtual address space of each target application process to one virtual memory space that corresponds to the target application process and is in the divided multiple virtual memory spaces; a unit 5030 for capturing access of the target application process to a virtual memory space other than the corresponding virtual memory space in the multiple virtual memory spaces; and a unit 5040 for simulating a captured remote memory access behavior. Each unit in FIG. 5 may include a processor, an electronic equipment, hardware, an electronic component, a logic circuit, a storage, or any combination thereof, or may be implemented by using the foregoing equipment.

FIG. 6 shows a host machine implemented according to an embodiment of the present invention. As shown in FIG. 6, the host machine 6000 includes: a storage 6020, for providing a memory address space; a processor 6010, configured to divide multiple virtual memory spaces in the storage; set a virtual address space of each target application process to one virtual memory space that corresponds to the target application process and is in the divided multiple virtual memory spaces; and capture access of the target application process to a virtual memory space other than the virtual memory space corresponding to the target application process in the multiple virtual memory spaces.

The steps of the method described here may be directly embodied by hardware, software executed by a processor or a combination thereof, and the software may be in a storage medium. According to an embodiment of the present invention, the host machine of the present invention may execute the instruction through the processor to implement simulation of the remote memory access. The instruction for implementing the remote memory access simulation method described with reference to FIG. 2 and FIG. 3 is stored in the storage, and the processor executes the instruction to implement the simulation method of the remote memory access. The technical solutions of the present invention or the part that makes contributions to the prior art may be substantially embodied in the form of a software product. The computer software product is stored in a readable storage medium, and includes several instructions to instruct a computer equipment (may be a personal computer, a server, or a network equipment) to perform all or a part of the methods described in the embodiments of the present invention. The foregoing storage medium be any medium that is capable of storing program codes such as a USB flash disk, a removable hard disk, a read-only memory (ROM, Read-Only Memory), a random access memory (RAM, Random Access Memory), a magnetic disk or an optical disk.

1-20. (canceled)

21. A method for simulating remote memory access in a target machine on a host machine, the method comprising:
dividing multiple virtual memory spaces in the host machine;
setting a virtual address space of each target application process to one virtual memory space that corresponds to a target application process and is in the multiple virtual memory spaces; and
capturing access of the target application process to a virtual memory space other than the virtual memory space corresponding to the target application process in the multiple virtual memory spaces.

22. The method according to claim 21, wherein the multiple virtual memory spaces in the host machine correspond respectively to multiple physical memory spaces of multiple nodes in the target machine that is simulated, and the target application processes that are executed in the host machine respectively correspond to target machine processes that are executed in the target machine that is simulated.

23. The method according to claim 22, wherein dividing the multiple virtual memory spaces in the host machine further comprises:
dividing a total virtual memory space in the host machine, wherein a size of the total virtual memory space is equal to a sum of sizes of physical memories of the multiple nodes in the target machine; and
dividing the total virtual memory space into the multiple virtual memory spaces.

24. The method according to claim 21, wherein setting the virtual address space of each target application process comprises setting a process address space that each target application process is enabled to access to the virtual memory space corresponding to the target application process.

25. The method according to claim 21, wherein setting the virtual address space of each target application process comprises setting a size of a physical memory in configuration information of each target application process to a size of the virtual memory space that corresponds to the target application process.

26. The method according to claim 21, wherein the capturing comprises capturing a page fault interrupt generated because the target application process accesses a virtual memory space other than the virtual memory space corresponding to the target application process.

27. The method according to claim 21, wherein the capturing comprises:
capturing a page fault interrupt caused by the target application process on the host machine; and
judging whether a memory address that the target application process that causes the page fault interrupt intends to access is outside the virtual memory space corresponding to the target application process.

28. The method according to claim 21, wherein the capturing comprises:
adding a probe on a system form feed function of the host machine;
capturing a page fault interrupt on the host machine to respond to the probe that is triggered;
judging whether an application process that causes the page fault interrupt is the target application process; and
if the application process that causes the page fault interrupt is the target application process, judging whether a memory address that the target application process that causes the page fault interrupt intends to access is outside the virtual memory space corresponding to the target application process.

29. The method according to claim 21, further comprising simulating remote memory access on the target machine corresponding to the captured access according to a model of an interconnection network between multiple nodes in the target machine.

30. A simulator for simulating remote memory access in a target machine, the simulator comprising:
a memory mapping module, configured to divide multiple virtual memory spaces in a host machine;
an application process setting module, configured to set a virtual address space of each target application process to one virtual memory space that corresponds to the target application process and is in the multiple virtual memory spaces; and
a capture module, configured to capture access of the target application process to the virtual memory space other than the virtual memory space corresponding to the target application process in the multiple virtual memory spaces.

31. The simulator according to claim 30, wherein the multiple virtual memory spaces in the host machine respectively correspond to multiple physical memory spaces of multiple nodes in the target machine that is simulated, and the target application processes that are executed in the host machine respectively correspond to target machine processes that are executed in the target machine that is simulated.

32. The simulator according to claim 31, wherein the memory mapping module is further configured to:
divide a total virtual memory space in the host machine, where a size of the total virtual memory space is equal to a sum of sizes of physical memories of the multiple nodes in the target machine; and
divide the total virtual memory space into the multiple virtual memory spaces.

33. The simulator according to claim 30, wherein the application process setting module is further configured to set a process address space that each target application process is enabled to access to a virtual memory space corresponding to the target application process.

34. The simulator according to claim 30, wherein the application process setting module is further configured to set a size of a physical memory in configuration information of each target application process to a size of the virtual memory space that corresponds to the target application process.

35. The simulator according to claim 30, wherein the capture module is further configured to capture a page fault interrupt generated because the target application process accesses a virtual memory space other than the virtual memory space corresponding to the target application process.

36. The simulator according to claim 30, wherein the capture module is further configured to:
capture a page fault interrupt caused by the target application process on the host machine; and
judge whether a memory address that the target application process that causes the page fault interrupt intends to access is outside the virtual memory space corresponding to the target application process.

37. The simulator according to claim 30, wherein the capture module is further configured to:
add a probe on a system form feed function of the host machine;
capture a page fault interrupt on the host machine to respond to that the probe is triggered;
judge whether an application process that causes the page fault interrupt is the target application process; and
if the application process that causes the page fault interrupt is the target application process, judge whether a memory address that the target application process that causes the page fault interrupt intends to access is outside the virtual memory space corresponding to the target application process.

38. The simulator according to claim 30, further comprising:
an interconnection network simulation module, configured to simulate, according to a model of an interconnection network between multiple nodes in the target machine, remote memory access on the target machine corresponding to the captured access.

39. A system for simulating remote memory access, the system comprising:
a storage, configured to store an instruction; and
a processor, configured to execute the instruction, so as to enable the system to execute the steps of:
dividing multiple virtual memory spaces in a host machine;
setting a virtual address space of each target application process to one virtual memory space that corresponds to a target application process and is in the multiple virtual memory spaces; and
capturing access of the target application process to a virtual memory space other than the virtual memory space corresponding to the target application process in the multiple virtual memory spaces.

40. A non-transitory machine-readable medium, wherein an instruction is stored, and when a machine executes the instruction, the machine is enabled to execute the steps of:
dividing multiple virtual memory spaces in a host machine;
setting a virtual address space of each target application process to one virtual memory space that corresponds to a target application process and is in the multiple virtual memory spaces; and
capturing access of the target application process to a virtual memory space other than the virtual memory space corresponding to the target application process in the multiple virtual memory spaces.
